(19) United States
(12) Patent Application Publication
(10) Pub. No.: US 2023/0415509 A1
(43) Pub. Date: Dec. 28, 2023

(54) WHEEL HUB SEAL

(71) Applicant: Consolidated Metco, Inc., Vancouver, WA (US)

(72) Inventors: Connor Regan, Vancouver, WA (US); Xin Yu, Vancouver, WA (US); Gregg Smith, Vancouver, WA (US); Connor Koester, Vancouver, WA (US)

(21) Appl. No.: 18/212,436

(22) Filed: Jun. 21, 2023

Related U.S. Application Data
(60) Provisional application No. 63/354,350, filed on Jun. 22, 2022.

(51) Int. Cl. B60B 27/00; B60B 27/02; F16J 15/40; F16C 33/76

(52) U.S. Cl. CPC B60B 27/0073; B60B 27/0094; B60B 27/02; F16J 15/406; F16C 33/766; B60B 2380/70; B60B 2900/5118; F16C 2326/02

(57) ABSTRACT

In one aspect, a wheel hub oil seal including an annular seal having a central opening to receive a vehicle spindle. The annular seal has an oil side for being contacted by oil in the wheel hub and an air side of the annular seal opposite the oil side. The annular seal has a radially outer mounting portion configured to sealingly engage an interior surface of the wheel hub. The annular seal includes a sealing member having a contact portion configured to form a dynamic seal with a running surface. The contact portion of the sealing member has an underlip pressure profile configured to pump oil toward the oil side of the annular seal upon rotation of the radially outer mounting portion of the annular seal with the wheel hub around the vehicle spindle.

### CROSS-REFERENCE TO RELATED APPLICATION

This application claims benefit of U.S. Provisional Application No. 63/354,350, filed Jun. 22, 2022, which is hereby incorporated herein by reference in its entirety.

### FIELD

This disclosure relates to wheel hub assemblies for vehicles and, more particularly, to wheel hub assemblies having seals that protect bearing assemblies of the wheel hub assemblies.

### BACKGROUND

Wheel hub assemblies are used to connect wheels to axles of vehicles. Some axles are drive axles, which include spindles at the ends of the axle and semi-shafts in the spindles. Wheel hub assemblies used with drive axles include a wheel hub and bearing assemblies to rotatably mount the wheel hub to a spindle. The wheel hub is connected to the semi-shaft in the spindle such that rotation of the semi-shaft causes rotation of the wheel hub.

Wheel hub assemblies are typically filled with a lubricant, such as oil, for lubricating the bearing assemblies of the wheel hub assemblies. In some vehicles, the bearing assemblies of the wheel hub assemblies are in fluid communication with an interior of the associated axle such that lubricant may travel between the bearing assemblies and the interior of the axle. The lubricant may thereby lubricate both the bearings of the wheel hub assemblies and components in the interior of the axle such as a differential. One shortcoming with these systems is that, over time, leakage of lubricant into the axle may reduce the volume of lubricant in the wheel hub assemblies to an undesirable level and shorten the lifespan of the wheel hub assemblies.

### SUMMARY

In one aspect, an oil seal is provided for a wheel hub. The oil seal has an annular seal configured to inhibit the flow of oil through the seal and has a central opening to receive a vehicle spindle. The seal has an oil side of the seal for being contacted by oil in the wheel hub and has an air side of the seal opposite the oil side. The seal has a radially outer mounting portion configured to sealingly engage an interior surface of the wheel hub and permit rotation of the radially outer mounting portion of the seal with the wheel hub around the vehicle spindle. The seal further includes a sealing member having a contact portion configured to form a dynamic seal with a running surface. One of the sealing member and the running surface is rotatable with the radially outer mounting portion of the seal relative to the other of the sealing member and the running surface. Further, the contact portion of the sealing member is configured to form a pressure profile with the running surface that pumps oil toward the oil side of the seal upon rotation of the radially outer mounting portion of the seal with the wheel hub around the vehicle spindle. In this manner, the oil seal provides a compact approach for retaining lubricant within the wheel hub and facilitates the use of a minimal lubricant fill level in the associated vehicle axle.

Additionally, the pressure profile formed by the sealing member and the contact surface is opposite the underlip pressure of a grease seal of a conventional unitized bearing assembly. More specifically, the grease seal of a conventional unitized bearing assembly is configured to pump dirt and other debris away from the grease-facing side of the seal. Thus, the grease seal of a conventional unitized bearing assembly would be unable to retain oil within the associated wheel hub because the seal would pump oil out of the wheel hub rather than retaining the oil within the wheel hub.

In another aspect of the present disclosure, a wheel hub assembly is provided that includes a wheel hub body having an inboard end, an outboard end, and a bore extending therebetween to receive a vehicle spindle. The wheel hub body has an inner surface defining at least a portion of the bore of the wheel hub body. The wheel hub assembly has an inboard bearing assembly and an outboard bearing assembly in the bore of the wheel hub body. Each of the inboard and outboard bearing assemblies include an inner race, an outer race, and a plurality of bearings between the inner and outer races that facilitate rotation of the outer race around the inner race.

The wheel hub assembly includes an oil seal to inhibit oil from flowing in an outboard direction beyond the oil seal. The oil seal has a sealing member, a running surface, and a mounting portion engaged with the inner surface of the wheel hub body outboard of the outer race of the outboard bearing assembly. One of the sealing member and the running surface rotates with the mounting portion upon rotation of the wheel hub around the vehicle spindle relative to the other of the sealing member and the running surface. The oil seal limits leakage of oil in a generally outboard direction from the outboard bearings, thereby keeping the outboard and inboard bearings lubricated throughout the lifespan of the wheel hub assembly.

The present disclosure also provides a method of assembling a wheel hub assembly. The method includes advancing a first seal body of an oil seal into a bore of a wheel hub body in an inboard direction toward an outer race of an outboard bearing assembly in the bore and engaging a mounting portion of the first seal body of the oil seal with the wheel hub body outboard of the outer race of the outboard bearing assembly. The method further includes arranging a sealing member and a running surface of the oil seal so that the sealing member and running surface form a dynamic seal therebetween, wherein one of the sealing member and the running surface rotates with the wheel hub body relative to the other of the sealing member and the running surface. The method thereby facilitates installation of an oil seal to retain oil in wheel hub assembly.

### BRIEF DESCRIPTION OF THE DRAWINGS

FIG. 1 is a cross-sectional view of wheel ends and a drive axle with semi-shafts of the drive axle removed to illustrate lubricant fill levels of the drive axle.

FIG. 2 is an enlarged view of one of the wheel ends of FIG. 1 showing a wheel hub assembly of the wheel end.

FIG. 3A is a cross-sectional view of a portion of the wheel end of FIG. 2, FIG. 3A showing a semi-shaft connected to the wheel hub assembly and a lubricant seal of the wheel hub assembly according to a first embodiment.

FIG. 3B is a perspective view of the portion of the wheel end shown in FIG. 3A.

FIG. 4 is a cross-sectional view of a portion of a wheel end of FIG. 2, FIG. 4 showing the wheel hub assembly having a lubricant seal according to a second embodiment.

FIG. 5 is a cross-sectional view of a portion of the wheel end of FIG. 2, FIG. 5 showing the wheel hub assembly having a lubricant seal according to a third embodiment.

FIG. 6 is a cross-sectional view of a portion of the wheel end of FIG. 2, FIG. 6 showing the wheel hub assembly having a lubricant seal according to a fourth embodiment.

FIG. 7 is a cross-sectional view of a portion of the wheel end of FIG. 2, FIG. 7 showing the wheel hub assembly having a lubricant seal according to a fifth embodiment.

### DETAILED DESCRIPTION

A lubricant seal is provided herein for sealing lubricant within a wheel hub assembly. The seal inhibits lubricant from flowing out of the wheel hub assembly to the drive axle. By retaining lubricant within the wheel hub assembly, lubricant may be replenished less frequently. For example, the wheel hub assembly may not receive lubricant from the interior of the drive axle. As a result, the volume of lubricant within the drive axle can be reduced which reduces the cost of filling and replacing the fluid in the drive axle and may reduce the weight of the vehicle.

Another advantage of the seal is that the lubricant maintained in the wheel hub assembly by the seal may be different than the lubricant in the drive axle. For example, the drive axle may utilize a lower-viscosity lubricant while the wheel hub assembly utilizes a higher-viscosity lubricant. The seal keeps the higher-viscosity lubricant in the wheel hub assembly rather than permitting the higher-viscosity lubricant to escape.

In one embodiment, the seal includes a first seal body configured to be mounted to a wheel hub body of the wheel hub assembly and/or an outboard bearing cup of the wheel hub assembly. The seal further includes a second seal body configured to be mounted to a mounting portion of an outboard bearing cone of the wheel hub assembly. The mounting portion of the outboard bearing cone includes an axial extension for supporting the second seal body thereon. The seal system further includes a sealing member, such as a lip seal, of one of the first and second seal bodies. The sealing member is configured to form a dynamic seal with the other of the first and second seal bodies. The seal keeps lubricant within the wheel hub assembly during operation of the vehicle. In one embodiment, the second seal body includes one or more vents that permit air to escape the wheel hub assembly while inhibiting fluid from escaping the wheel hub assembly. Permitting air to escape the wheel hub assembly avoids high internal air pressures within the wheel hub assembly that may damage seals of the wheel hub assembly.

In another embodiment, the seal includes a seal body mounted to a wheel hub body of the wheel hub assembly and/or an outboard bearing cup of the wheel hub assembly. The seal includes a sealing member of the seal body. The sealing member is configured to contact a running surface of a portion of the outboard bearing cone. The seal body and sealing member thereof rotate with the wheel hub and relative to the running surface of the outboard bearing cone during operation of the vehicle. The sealing member forms a dynamic seal with the running surface of the outboard bearing cone and retains lubricant within the wheel hub assembly. In some embodiments, the seal includes a garter spring urging the sealing member against the running surface.

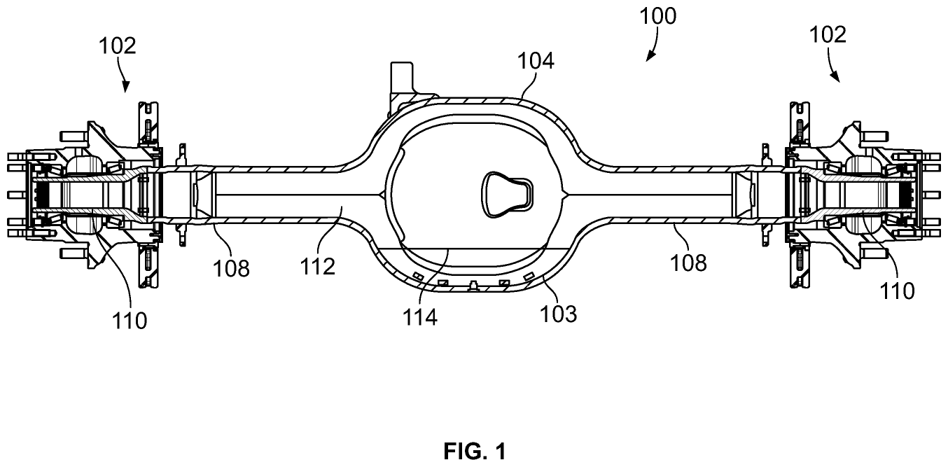

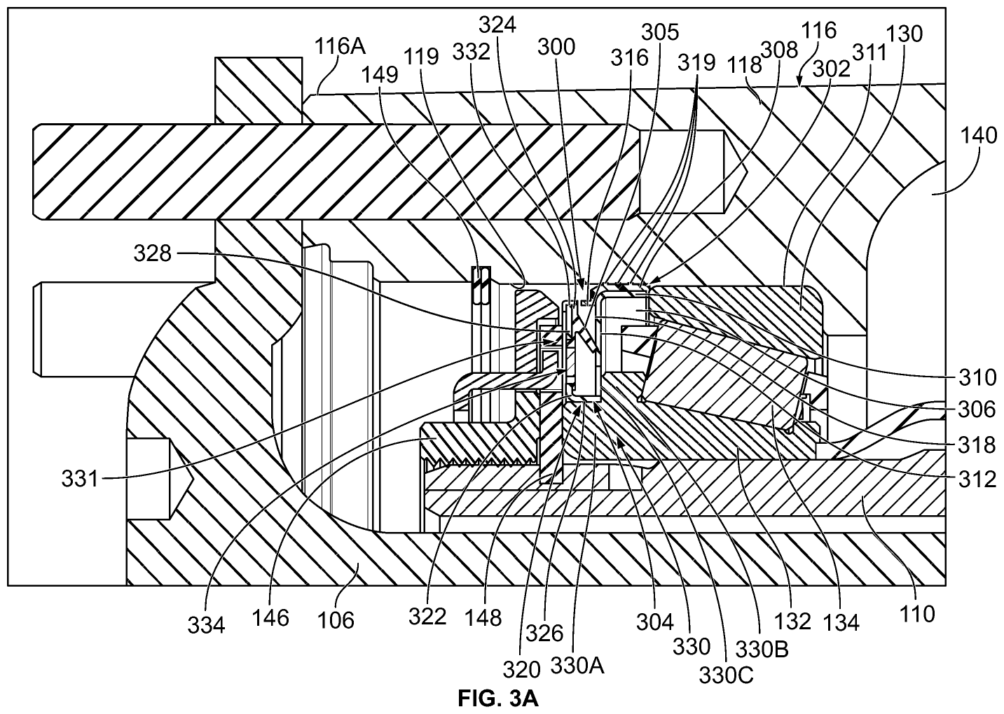

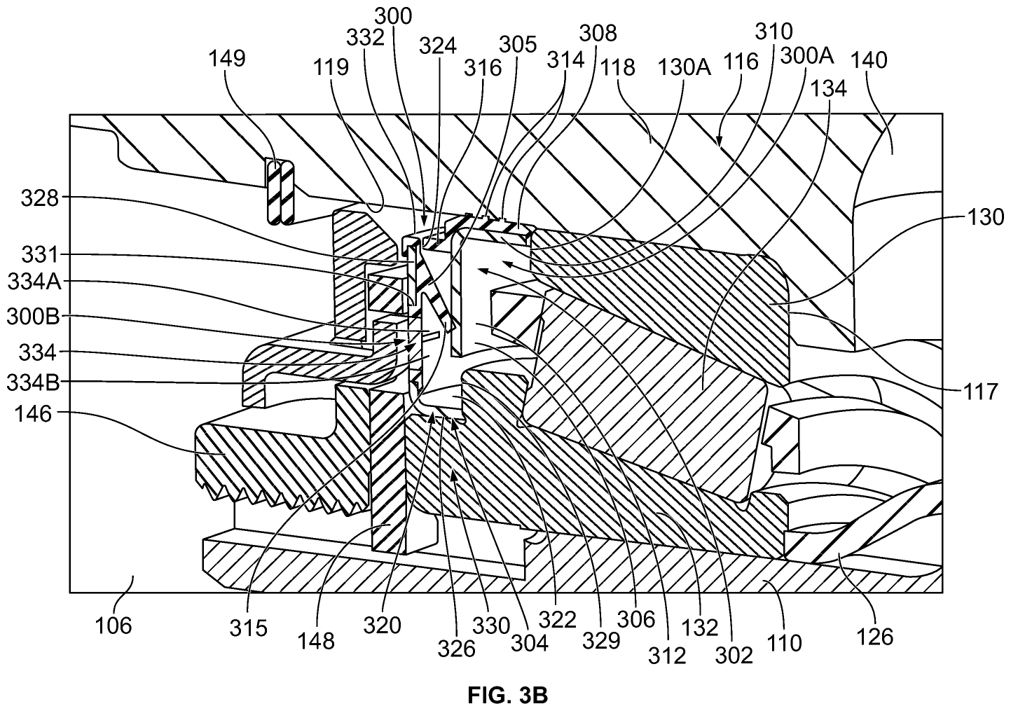

With respect to FIG. 1, a drive axle 100 of a vehicle is provided having wheel hub assemblies 102 attached to the ends of the drive axle 100. The drive axle 100 includes a housing 103 having a differential housing portion 104 for containing a differential gear system connected to semi-shafts 106 (see FIG. 3A) that extend through shaft housing portion 108 to the wheel hub assemblies 102. The ends of the shaft housing portions 108 include spindles 110 to which the wheel hub assemblies 102 are mounted and rotate about. The housing 103 contains lubricant for lubricating the differential gear system. With reference to FIG. 1, in some prior drive axles, the housing of the drive axle is filled with lubricant up to the line 112 to ensure that the lubricant travels along the shaft housing portions 108 to replenish the lubricant in the wheel hub assemblies 102. As described in further detail below, using the seals described herein, the fill level of lubricant in the housing 103 may be reduced for example to the line 114 because the wheel hub assemblies 102 have seals that retain lubricant within the wheel hub assemblies 102 rather than relying on lubricant from within the housing 103 to lubricate bearing assemblies of the wheel hub assemblies 102.

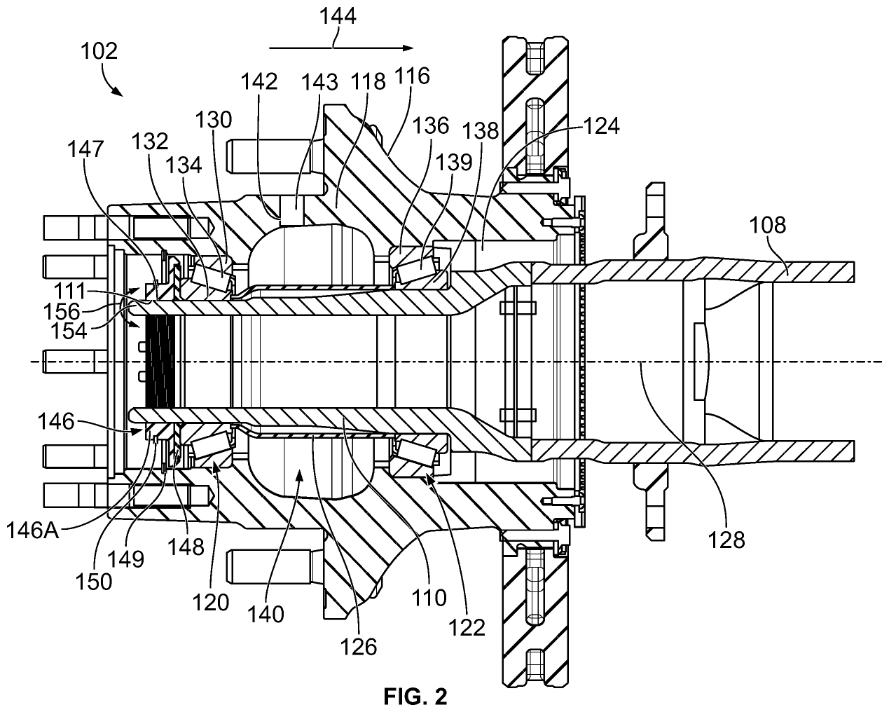

With respect to FIG. 2, one of the wheel hub assemblies 102 is shown mounted to the spindle 110 of the drive axle 100. The wheel hub assembly 102 shown in FIG. 2 permits lubricant to flow between the wheel hub assembly 102 and the drive axle 100 along flow path 156. The wheel hub assembly 102 includes a wheel hub 116 having a hub body 118, a mounting flange of the hub body 118, and studs protruding from the flange for mounting a wheel thereto. The wheel hub assembly 102 further includes an outboard bearing assembly 120, an inboard bearing assembly 122, an inboard seal 124, and a spacer 126. The spacer 126 is configured to maintain a predetermined axial distance between the outboard and inboard bearing assemblies 120, 122. The hub body 118 may have a unitary, one-piece construction and may be made of a metallic material such as steel, iron, or aluminum as some examples. The wheel hub assembly 102 is assembled onto the spindle 110. The outboard and inboard bearing assemblies 120, 122 permit the hub body 118 to rotate on the spindle 110 around central axis 128.

The outboard bearing assembly 120 includes an outer race such as an outboard bearing cup 130, an inner race such as the outboard bearing cone 132, and bearings such as roller bearings 134. The inboard bearing assembly 122 includes an outer race such as the inboard bearing cup 136, an inner race such as the inboard bearing cone 138, and bearings such as roller bearings 139. The hub body 118 forms a grease pocket 140 for containing lubricant such as oil for the bearing assemblies 120, 122. The hub body 118 may include a port 142 through which the grease pocket 140 may be filled with lubricant. The term filled with lubricant as used herein is intended to encompass a volume that permits normal operation of the components to be lubricated, such as partially filled. The port 142 may include a removable plug 143 for sealing the port 142 and permitting access to the grease pocket 140, for example, to add lubricant to the wheel hub assembly 102.

The wheel hub assembly 102 is mounted on the spindle 110 by advancing the wheel hub 116 in direction 144 along the spindle 110. The outboard and inboard bearing assemblies 120, 122 and spacer 126 have central openings that receive the spindle 110. The wheel hub assembly 102 includes a spindle nut 146 to secure the wheel hub assembly 102 to the spindle 110. The spindle nut 146 includes inner threads 147 that engage outer threads 111 of the spindle 110. The spindle nut 146 has a drive head portion 146A that is used to rotate the spindle nut 146 to secure the wheel hub 116 to the vehicle. The drive head portion 146A may have a hexagonal cross-section enabling a wrench or socket to be used to turn the spindle nut 146. The wheel hub assembly 102 may be advanced along the spindle 110 by threading the spindle nut 146 onto the spindle 110. The wheel hub assembly 102 may further include a locking washer 148, a spiral locking ring 149, and a locking ring 150 for securing the spindle nut 146 to the spindle 110 and preventing the spindle nut 146 from rotating relative to the spindle 110 (e.g., unintentionally loosening or unthreading). The locking washer 148 includes a tab that extends into a keyway 154 of the spindle 110 to inhibit rotation of the locking washer 148 relative to the spindle 110. The locking ring 150 includes a tab that extends through the spindle nut 146 and the locking washer 148 to secure the spindle nut 146 to the locking washer 148 and inhibit the spindle nut 146 from rotating relative to the locking washer 148 and the spindle 110 (e.g., unthreading from the spindle 110).

FIGS. 3A-6 illustrate the wheel hub assembly 102 with seals according to various embodiments of this disclosure that inhibit lubricant from flowing between the interior of the wheel hub assembly 102 and the interior of the drive axle 100. These seals retain the lubricant within the wheel hub assembly 102 which reduces reliance of the wheel hub assembly 102 on lubricant from the drive axle 100. The seals also limit the volume of fluid exchanged between the drive axle 100 and the wheel hub assembly 102 which limits mixing of the lubricant of the drive axle 100 and the lubricant of the wheel hub assembly 102. Isolation of the lubricant of the wheel hub assembly 102 allows the lubricant of wheel hub assembly 102 to be different than the lubricant of the drive axle 100. For example, the lubricant of the wheel hub assembly 102 and the lubricant of the drive axles 100 may both be oils, but the oil of the wheel hub assembly 102 may have a different viscosity grade than the oil of the drive axle 100. As another example, the lubricant of the wheel hub assembly 102 may be a grease whereas the lubricant of the drive axle 100 may be an oil. While the seals are described as being used with wheel hub assemblies 102 of drive axle 100, the seals may similarly be used with non-driven wheel hub assemblies to retain lubricant within the wheel hub assembly. Additionally, while the following discussion describes various embodiments by way of example, it should be appreciated that the features and elements of one embodiment may be modified and/or combined with features and elements of one or more of the other embodiments.

With respect to FIGS. 3A-3B, the wheel hub assembly 102 includes a seal 300 that inhibits lubricant from flowing out of an interior of the wheel hub assembly 102 (e.g., out of the grease pocket 140) and to the drive axle 100. The seal 300 has an oil side 300A and an air side 300B. The seal 300 includes an inboard seal body 302, an outboard seal body 304, and a sealing member such as lip sealing member 305 extending between the inboard seal body 302 and outboard seal body 304. The inboard seal body 302 is annular and sized to be inserted into a bore 119 of the body 118 of the wheel hub 116. The inboard seal body 302 includes a structural member 306 and a sealing layer 308. The sealing layer 308 may include, for example, a sleeve extending around the structural member 306. The structural member 306 may be made of a rigid material such as a metallic material such as steel, a plastic material, and/or a composite material such as fiber reinforced plastic. The sealing layer 308 may be formed of a polymer material such as a nitrile rubber as an example. The sealing layer 308 may be bonded to the structural member 306 and include protrusions such as ridges 319 to ensure an oil-tight seal between the sealing layer 308 and the inner diameter of the bore 119 of the wheel hub 116.

The structural member 306 includes an axial portion 310 and a radial portion 312 extending radially inward from the axial portion 310. The sealing layer 308 may extend over a radial outer surface of the inboard seal body 302, for example, on an outer surface of the axial portion 310 of the inboard seal body 302. The sealing layer 308 forms a fluid tight seal with an inner surface 311 of the wheel hub body 118 when the inboard seal body 302 is inserted (e.g., pressed) into the bore 119 of the wheel hub 116. The sealing layer 308 may also wrap around the inboard end of the axial portion 310. When the inboard seal body 302 is inserted into the bore 119, the inboard seal body 302 may be inserted until the sealing layer 308 on the inboard end of the axial portion 310 contacts and forms a seal with the outboard bearing cup 130 of the wheel hub assembly 102. Pressing the inboard seal body 302 against the outboard bearing cup 130 also ensures that the inboard seal body 302 is installed to a set and predictable location within the wheel hub 116. The axial dimension of inboard seal body 302 may aid to keep the inboard seal body 302 substantially aligned with the bore 119 of the wheel hub 116 (e.g., as the inboard seal body 302 is inserted into the bore 119) and to inhibit the inboard seal body 302 from pivoting out of alignment with the bore 119.

When the wheel hub 116 is rotating about the spindle 110, the bearings 134 and outboard bearing cup 130 fling oil outboard against the structural member 306. The oil impacts the structural member 306, rather than the lip sealing member 305, which preserves the integrity of the seal between the lip sealing member 305 and the structural member 306.

The inboard seal body 302 may mount to the wheel hub 116 by an interference fit connection. For example, the sealing layer 308 may have an outer diameter that is slightly larger than the diameter of the bore 119 of the wheel hub 116. The inboard seal body 302 may be pressed into the bore 119 of the wheel hub 116 to attach the inboard seal body 302 to the wheel hub 116. The inboard seal body 302 may be held in place by the frictional engagement between the inboard seal body 302 and the wheel hub 116. The sealing layer 308 further aids to inhibit the inboard seal body 302 from rotating substantially within the wheel hub 116 and thus forms a static seal between the inboard seal body 302, the wheel hub 116, and the outboard bearing cup 130. The sealing layer 308 may include one or more ribs 314 extending radially outward of the inboard seal body 302. The ribs 314 may provide regions of increased frictional engagement between the inboard seal body 302 and the wheel hub 116. The ribs 314 may aid to form the fluid tight seal between the inboard seal body 302 and the wheel hub 116. The inboard seal body 302 is thus prevented from moving axially relative to the wheel hub 116 and from rotating within the wheel hub 116. Thus, when the wheel hub 116 is rotated, the inboard seal body 302 rotates with the wheel hub 116.

The sealing layer 308 may include an annular flange 316 extending axially from the radial portion 312 of the inboard seal body 302. When the inboard seal body 302 and the outboard seal body 304 are installed in the wheel hub 116, the flange 316 of the inboard seal body 302 extends toward the outboard seal body 304 to further inhibit fluid from passing between the inboard and outboard seal bodies 302, 304. The radial portion 312 of the inboard seal body 302 includes a sealing surface 318 which the lip sealing member 305 engages to form a fluid tight connection therebetween as described in further detail below.

The outboard seal body 304 is annular and has a central opening 320 sized to be mounted to the outboard bearing cone 132. The outboard seal body 304 includes a structural member 322 and a sealing layer 324. The structural member 322 may be formed of a rigid material such as a metallic material such as steel, a plastic material, and/or a composite material such as fiber reinforced plastic. The sealing layer 324 may be formed of a polymer material such as a nitrile rubber as an example. The sealing layer 324 may be bonded to the structural member 322.

The structural member 322 has a sleeve portion, such as an axial portion 326, and a flange portion, such as a radial portion 328, extending radially outward of the axial portion 326. The axial portion 326 defines the central opening 320 for assembling the outboard seal body 304 with the outboard bearing assembly 120. As shown in FIGS. 3A-3B, the outboard bearing cone 132 has a mounting portion 330. The mounting portion 330 includes an extension portion 330A and a flange portion 330B. The extension portion 330A and flange portion 330B form an annular notch in the exterior of the outboard seal body 304. The extension portion 330A has a smaller outer diameter than the flange portion 330B forming step 330C that operates as a stop for the outboard seal body 304 as the outboard seal body 304 is advanced in an inboard direction onto the outboard bearing cone 132. The extension portion 330A has an outer diameter sized to be received in the central opening 320 of the outboard seal body 304. The outboard seal body 304 may be pressed onto the mounting portion 330 of the outboard bearing cone 132 to attach the outboard seal body 304 to the outboard bearing assembly 120. The outboard seal body 304 may be pressed onto the extension portion 330A of the outboard bearing cone 132 until the axial portion 326 of the outboard seal body 304 seats against a stop surface 329 (see FIG. 3B) of the shoulder portion 330C. The outboard bearing cone 132 thereby provides a hard stop to axially locate the outboard seal body 304 relative to the outboard bearing assembly 120. Further, the press-fit of the axial portion 326 onto the extension portion 330A provides an oil-tight seal therebetween. In one embodiment, the outboard seal body 304 includes a layer of resilient material on the inner diameter of the axial portion 326 to further improve sealing between the outboard seal body 304 and the outboard bearing cone 132.

The outer diameter of the extension portion 330A of the outboard bearing cone 132 and the inner diameter of the central opening 320 of the outboard seal body 304 are sized to create an interference fit between the outboard bearing cone 132 and the outboard seal body 304. For example, the outer diameter of the extension portion 330A may be larger than an inner diameter of the central opening 320. The frictionally engaged radially outer surface of the extension portion 330A and the radially inner surface of the axial portion 326 fixes the outboard seal body 304 and outboard bearing cone 132 against relative axial and rotational movement.

In some embodiments, the structural member 322 directly engages the mounting portion 330 of the outer bearing cone 132. In embodiments where the structural member 322 of the outboard seal body 304 is made of a metallic material, the metal-on-metal engagement of the outboard seal body 304 with the mounting portion 330 attaches the outboard seal body 304 to the mounting portion 330 and forms a fluid tight connection therebetween. In some embodiments, a seal layer is attached to the radially inner surface of the axial portion 326 of the outboard seal body 304 to aid in forming a fluid tight seal with the mounting portion 330 of the outer bearing cone 132.

With reference to FIG. 3B, the sealing layer 324 may be bonded to the radial portion 328 of the structural member 322 of the outboard seal body 304. The radial portion 328 of the structural member 322 may include one or more holes 331 that receive a vent through which gas (e.g., air) is able to be vented. The sealing layer 324 may include an annular channel 332 that receives a radially outer edge of the structural member 322. The channel 332 wraps around the radially outer edge of the structural member 322 and provides a mechanical interlock to resist separation of the sealing layer 324 and the structural member 322.

The sealing layer 324 of the outboard seal body 324 includes the lip sealing member 305. The lip sealing member 305 protrudes from the structural member 322 to contact the sealing surface 318 (see FIG. 3A) of the inboard seal body 302. In other forms, the lip sealing member 305 may be mounted to the structural member 306 and protrude to contact the outboard seal body 304. The lip sealing member 305 may be elastically deflectable such that when the outboard seal body 304 is attached to the mounting portion 330 of the outboard bearing cone 132, the lip sealing member 305 is brought into contact with the sealing surface 318 of the inboard seal body 302 and is deflected slightly such that the lip sealing member 305 applies a resilient reaction force axially and against the sealing surface 318. The sealing surface 318 of the inboard seal body 302 rotates relative to the lip sealing member 305 as the wheel hub 116 rotates. The lip sealing member 305 remains in contact with the sealing surface 318 as the sealing surface 318 rotates thereby forming a dynamic seal. The lip sealing member 305 inhibits lubricant contained in the wheel hub 116 from flowing out of the wheel hub assembly 102 to the drive axle 100.

The lip sealing member 305 has a free end portion 315 (see FIG. 3B) in contact with the sealing surface 318. The free end portion 315 may be shaped to create a pressure differential between the radially inner side and radially outer side of the free end portion 315. Alternatively or additionally, the free end portion 315 may include ridges shaped to create such a pressure differential between the radially inner side and radially outer side of the free end portion 315. For instance, the tip and/or ridges of the free end portion 315 may have a radially inner surface portion and a radially outer surface portion that each extend away from the sealing surface 318 at an angle. The radially inner surface portion may extend at a steeper angle relative to the sealing surface 318 than the radially outer surface portion such that lubricant that attempts to travel radially outward between the lip sealing member 305 and sealing surface 318 is pumped radially inward by the free end portion 315 due to the engagement of the free end portion 315 with the sealing surface 318 and the rotation of the sealing surface 318. For example, the radially inner surface portion of the free end portion 315 may approach the sealing surface 318 at a 40-70 degree angle and the radially outer surface portion may approach the sealing surface 318 at a 20-35 degree angle.

The sealing layer 324 may include one or more vents 334 (see FIG. 3B) formed in the sealing layer 324 to permit gas (e.g., air) to pass through the sealing layer 324. The vent 334 may include one or more slits (e.g., a straight slit or a plurality of intersecting slits) formed in the sealing layer 324. In FIG. 3B, the vent 334 has a pair of intersecting slits forming a “+” and the cross-section of FIG. 3B is extending through the radial slit of the vent 34. The portions 334A, 334B of the sealing layer 324 forming the vent 334 may be shifted from a closed configuration wherein the portions 334A, 334B are closely adjacent or contact one another to an open configuration wherein the portions 334A, 334B are spaced apart from one another in response to internal pressure in the wheel hub 116 exceeding a predetermined threshold. In the open configuration, the portions of the sealing layer 324 forming the vent 334 form an opening to allow gas to be vented therethrough. Once the internal pressure has fallen below the threshold, the resilient properties of the sealing layer 324 bias the portions 334A, 334B back together toward the closed configuration thereof. The one or more vents 334 may be formed in portions of the sealing layer 324 aligned with the one or more holes 331 of the structural member 322 so that gas passing through the vents 334 is able to pass through the holes 331 of the structural member 322. The vents 334 may be configured to permit gas to pass therethrough while inhibiting liquid such as the lubricating fluid from passing therethrough.

To install the seal 300 in the wheel hub 116, the outboard bearing cup 130 is pressed into the bore 119 of the wheel hub 116 and seats against a surface 117 (see FIG. 3B) of the wheel hub body 118. The roller bearings 134 and bearing cone 132 are positioned on the outboard bearing cup 130 while the wheel hub 116 is oriented vertically with an outboard end 116A of the wheel hub 116 pointing upward so that gravity keeps the roller bearings 134 and bearing cone 132 on the outboard bearing cup 130.

Next, the inboard seal body 302 is advanced downward into the bore 119 of the wheel hub 116, such as by pressing the inboard seal body 302 into the bore 119. The inboard seal body 302 is advanced axially in an inboard direction into the bore 119 of the wheel hub 116 until the axial portion 310 of the inboard seal body 302 seats against a stop, such as surface 130A (see FIG. 3B), of the outboard bearing cup 130. The inboard seal body 302 is configured to form a static seal between the wheel hub 116 and the inboard seal body 302 and secure the inboard seal body 302 to the wheel hub 116 by an interference fit.

The outboard seal body 304 is advanced into the wheel hub 116 with the central opening 320 of the outboard seal body 304 aligned with the extension portion 330A of the outboard bearing cone 132. The outboard seal body 304 is pressed onto the outboard bearing cone 132 so that the axial portion 326 of the structural member 322 travels along the annular radially outer surface of the extension portion 330A until the axial portion 326 seats against the flange portion 330B of the outboard bearing cone 132. The axial portion 326 of the outboard seal body 304 and the axial portion 310 of the inboard seal body 302 have axial extents sized to position the free end portion 315 of the lip sealing member 305 in engagement with the sealing surface 318 of the inboard sealing body 302 once the axial portion 326 and axial portion 310 are seated, respectively, against the outboard bearing cone 132 and the outboard bearing cup 130.

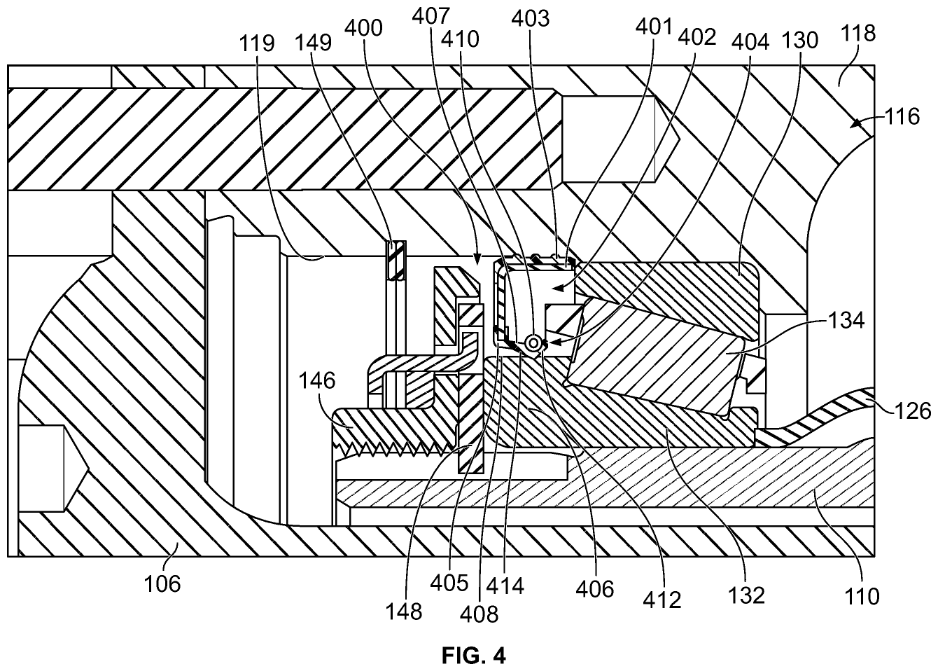

With respect to FIG. 4, a seal 400 is provided that is similar to the seal 300 of FIGS. 3A-3B such that the differences will be highlighted in the following discussion. The seal 400 includes a seal body 402 and a lip sealing member 404. The seal body 402 has a structural member 401 and a sealing layer 403. The structural member 401 may be made of a rigid material, such as a structural plastic, metallic material, or composite material. The lip sealing member 404 may be made of a polymer, such as a rubber such as nitrile rubber. The lip sealing member 404 has an attachment portion 405, such as a channel, engaged with a radially inner portion of the structural member 401. The lip sealing member 404 may be bonded to the structural member 401 and the attachment portion 405 provides a mechanical interlock that further inhibits separation of the sealing member 404 from the structural member 401.

When the seal body 402 is inserted into the bore 119 of the wheel hub 116, the lip sealing member 404 protrudes radially inward and engages a running or sealing surface, such as annular radially outer running surface 408, of a flange portion 406 of the outboard bearing cone 132. The lip sealing member 404 engages the running surface 408 in a radial direction, in contrast to the lip sealing member 305 that engages the sealing surface 318 in an axial direction. As the seal body 402 rotates with the wheel hub 116, the lip sealing member 404 remains in contact with the running surface 408, creating a dynamic, fluid tight seal therebetween.

In the embodiment of FIG. 4, a contact portion 407 of the lip sealing member 404 is biased toward the running surface 408 of the outboard bearing cone 132 by a resilient member, such as a garter spring 410. The garter spring 410 may be formed of a metallic material, such as steel. The garter spring 410 may be configured to maintain the contact portion of the lip sealing member 404 in engagement with the running surface 408, even as the lip sealing member 404 wears over time. Alternatively or additionally, the lip sealing member 404 may be elastically deflectable such that when the lip sealing member 404 engages the running surface 408 the lip sealing member 404 is deflected slightly radially outward such that the material of the lip sealing member 404 applies a resilient reaction force radially inward and against the running surface 408. In some embodiments, the lip sealing member 404 may be used without the garter spring 410 to reduce the frictional resistance between the lip sealing member 404 and the running surface 408.

The contact portion 407 of the lip sealing member 404 may be shaped to create a pressure differential between the inboard side and outboard side of the lip sealing member 404. The lip sealing member 404 includes an inboard surface 412 and an outboard surface 414 that each extend away from the running surface 408 at an angle. The inboard surface 412 extends at a steeper angle relative to the running surface 408 than the outboard surface 414 such that any lubricant urged outboard between the lip sealing member 404 and the running surface 408 is pumped inboard by the lip sealing member 404 upon rotation of the wheel hub 116. For example, the inboard surface 412 may approach the running surface 408 at an angle of 40-70 degrees and the outboard surface 414 may approach the running surface 408 at an angle of 20-35 degrees.

To install the seal system 400, the seal body 402 may be advanced into the bore 119 of the wheel hub 116 until the seal body 402 seats against the outboard bearing cup 130. The structural member 401 of the seal body 402 has an axial extent and a radial extent sized to position the contact portion 407 of the lip sealing member 404 in engagement with the running surface 408.

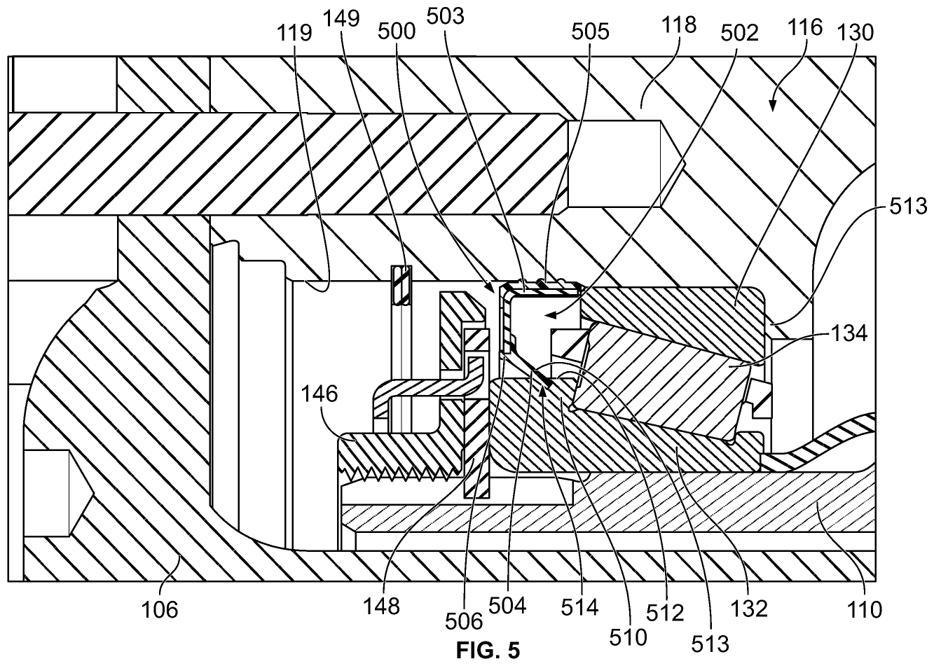

With respect to FIG. 5, a seal 500 is provided that is similar in many respects to the seal 400 of FIG. 4 such that the differences will be highlighted in the following discussion. The seal 500 includes a seal body 502 and a lip sealing member 504. The seal body 502 includes a structural member 503 and a sealing layer 505. Like the embodiment of FIG. 4, the embodiment of FIG. 5 includes the outboard bearing cone 132 having a flange portion 510 with an annular, radially outer running surface 512 which the lip sealing member 504 engages to form a fluid tight seal.

The lip sealing member 504 is mounted to the structural member 503. The lip sealing member 504 includes an attachment end 506 that is mounted to the radially inner end portion of the structural member 503. The lip sealing member 504 may be formed of a rubber material such as nitrile rubber as an example. The lip sealing member 504 may be elastically deflectable from the running surface 512 of the flange portion 510 such that when the seal body 502 is inserted into the bore 119 of the wheel hub 116, the lip sealing member 504 is deflected by the running surface 512. The material of the lip sealing member 504 is resilient and biases a contact portion 513 of the lip sealing member 504 into engagement with the running surface 512.

When installed, the lip sealing member 504 may be curved to position a radially inner surface of the contact portion 513 of the lip sealing member 504 in contact with the running surface 512. The radially inner surface of the contact portion 513 may include ridges 514 shaped to create a pressure differential between an outboard side and an inboard side of the lip sealing member 504. For instance, the ridges 514 of the lip sealing member 504 may have an inboard surface portion and an outboard surface portion that each extend away from the running surface 512 at an angle. The inboard surface portion may extend at a steeper angle relative to the running surface 512 than the outboard surface portion such that lubricant that attempts to travel in the outboard direction between the lip sealing member 504 and the running surface 512 is pumped inboard by the lip sealing member 504 due to the rotation of the lip sealing member 504 around the outboard bearing cone 132. For example, the inboard surface portion of the contact portion 513 may approach the running surface 512 at an angle of 40-70 degrees and the outboard surface of the contact portion 513 may approach the running surface 512 at an angle of 20-35 degrees.

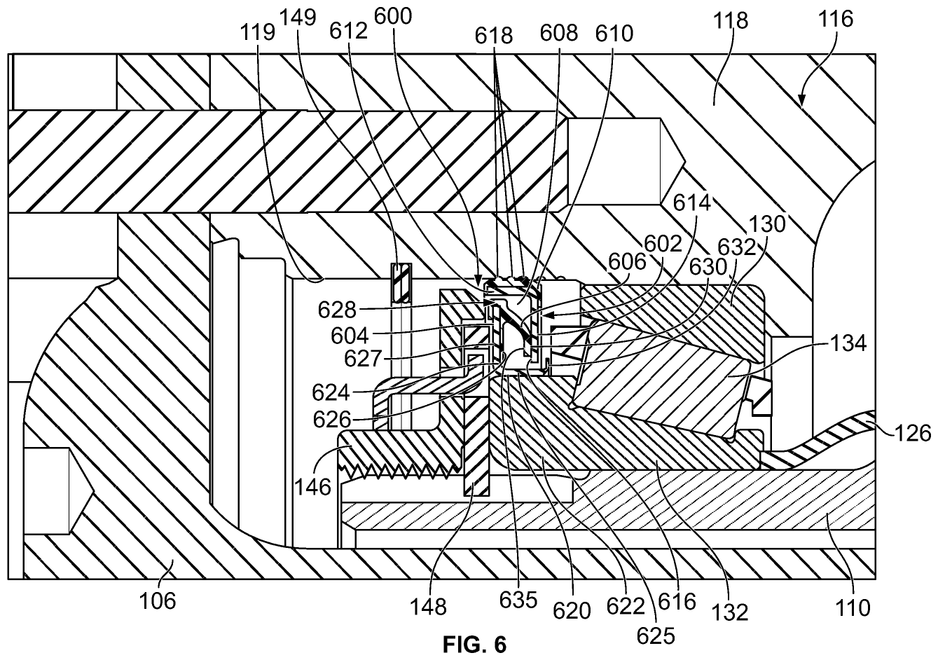

With respect to FIG. 6, a seal 600 is provided that is similar in many respects to the seal 300 of FIGS. 3A-3B such that the differences will be highlighted in the following discussion. The seal 600 includes a first seal body 602, a second seal body 604, and a lip sealing member 606. The first seal body 602 is similar to the inboard seal body 302 of FIGS. 3A-B, the first seal body 602 being annular and sized to be inserted into the bore 119 of the wheel hub 116. The first seal body 602 includes a structural member 608 and a sealing layer 610. The structural member 608 of the first seal body 602 may be formed of a rigid material such as a metallic material such as steel, a plastic material, and/or a composite material such as fiber reinforced plastic. The sealing layer 610 may be formed of a polymeric material such as a nitrile rubber as an example.

The structural member 608 of the first seal body 602 has an axial portion 612 and a radial portion 614 extending radially inward from the axial portion 612. The radial portion 614 has a running or sealing surface 616 that is engaged by the lip sealing member 606. The axial portion 612 of the first seal body 602 extends about the second seal body 604 such that the first seal body 602 overlaps the second seal body 604 in a radial direction. The overlapping first and second seal bodies 602, 604 provides a compact assembly of the first and second seal bodies 602, 604 in the wheel hub 116.

The first seal body 602 has an outer diameter sized to create an interference fit of the first seal body in the bore 119 of the wheel hub body 118. In one embodiment, the sealing layer 610 forms a fluid tight seal with the wheel hub body 118 and frictionally engages the inner surface of the wheel hub body 118 as described above with respect to other embodiments. Thus, when the wheel hub body 118 is rotated, the first seal body 602 rotates with the wheel hub body 118.

The second seal body 604 similar to the outboard seal body 304 of FIGS. 3A-3B, the second seal body 604 being annular and having a central opening 620 sized to receive a flange portion 622 of the outboard bearing cone 132. The flange portion 622 of the outboard bearing cone 132 extends axially along the spindle 110 in the outboard direction. The flange portion 622 622 has an annular, radially outer surface 624 on which the second seal body 604 is mounted.

The second seal body 604 has a structural member 624 and a sealing layer 626 that includes the lip sealing member 606. The structural member 624 may have an axial portion 625 that defines the central opening 620 and a radial portion 627 extending radially outward from the axial member 625. The second seal body 604 may include a flange 632 extending radially from the inboard end of the axial member 625. The flange 632 may retain the first seal body 602 on the second seal body 602. For example, flange 632 of the second seal body 604 may be bent radially outward after the axial member 625 is inserted through the central opening of the first seal body 602 to secure the first seal body 602 to the second seal body 604.

The sealing layer 626 and the lip sealing member 606 may be formed of a rubber material such as a nitrile rubber as an example. The sealing layer 626 may be secured to structural member 624 by chemical bonding, such as such as overmolding the sealing layer 626 on the structural member 624, or an adhesive as some examples. As shown, the sealing layer 626 is secured to the inboard surface of the radial portion 627 of the structural member 624. The sealing layer 626 may also include a pocket or channel 628 such that the sealing layer 626 wrap around a radially outer edge of the structural member 624. Having the sealing layer 626 wrap around the end of the structural member 624 may aid to keep the sealing layer 626 secured to the structural member 624.

The lip sealing member 606 extends from the structural member 624 toward the first seal body 602. As shown, the lip sealing member 606 may have an arcuate cross-sectional shape such that a free end portion 635 of the lip sealing member 606 contacts the sealing surface 616. The lip sealing member 606 may be elastically deflectable such that when the lip sealing member 606 has an initial, undeflected configuration wherein the lip sealing member 606 has a cross-section that is more straight than shown in FIG. 6. Assembling the seal 600 includes bringing the free end portion 635 into contact with the sealing surface 616, which deflects the lip sealing member 606 to a more bent, operating configuration as shown in FIG. 6. The material of the lip sealing member 606 resiliently biases the free end portion 635 against the sealing surface 616 and maintains the free end portion 635 in sealing engagement with the structural member 608.

The free end portion 635 may include ridges 630 shaped to create a pressure differential between a radially inner side and a radially outer side of the free end portion 635. For instance, the ridges of the free end portion 635 may each have a radially inner surface portion and a radially outer surface portion that extend away from the sealing surface 616 at an angle. The radially inner surface portion may extend at a steeper angle relative to the sealing surface 616 than the radially outer surface portion such that lubricant urged in the radially outward direction between the lip sealing member 606 and sealing surface 616 is pumped radially back inward by the lip sealing member 606 due to the rotation of the wheel hub 116. For example, the radially inner surface of the ridges of the lip sealing member 606 may approach the sealing surface 616 at an angle of 40-70 degrees and the radially outer surface of the lip sealing member 606 may approach the sealing surface 616 at an angle of 20-35 degrees.

To install the seal system 600, the first seal body 602 and second seal body 604 may be inserted into the wheel hub 116 together. As explained above, the flange 632 of the second seal body 604 may inhibit the first seal body 602 from being axially separated from the first seal body 602. The central opening 620 of the second seal body 604 may be aligned with the flange portion 622 of the outboard bearing cone 132. The second seal body 604 may be pressed onto the flange portion 622 with the flange portion 622 extending into the central opening 620 to secure the second seal body 604 to the flange portion 622 by an interference fit connection and form a static fluid tight seal therebetween. The first seal body 602 may be aligned with the bore 119 of the wheel hub body 118 and advanced axially into the bore 119 as the second seal body 604 is pressed onto the flange portion 622 of the outboard bearing cone 132. The first seal body 602 may be pressed into the bore 119 until the radial portion 614 of the first seal body 602 is spaced apart from the radial portion 627 of the second seal body 604 such that the ridges 630 of the free end portion 635 of the lip sealing member 606 contact the sealing surface 616 to form a rotatable, fluid tight connection.

An installation tool may be used to press the first seal body 602 and second seal body 604 into the bore 119 at the same time. The first seal body 602 and second seal body 604 may be placed on the installation tool. The installation tool may then be used to press the first seal body and second seal body 604 into the bore 119. The installation tool may maintain a predetermined axial spacing between the first seal body 602 and the second seal body 604 as the first and second seal bodies 602, 604 are advanced into the bore 119 to ensure the first and second seal bodies 602, 604 are properly spaced apart once the first and second seal bodies 602, 604 have been seated in the bore 119.

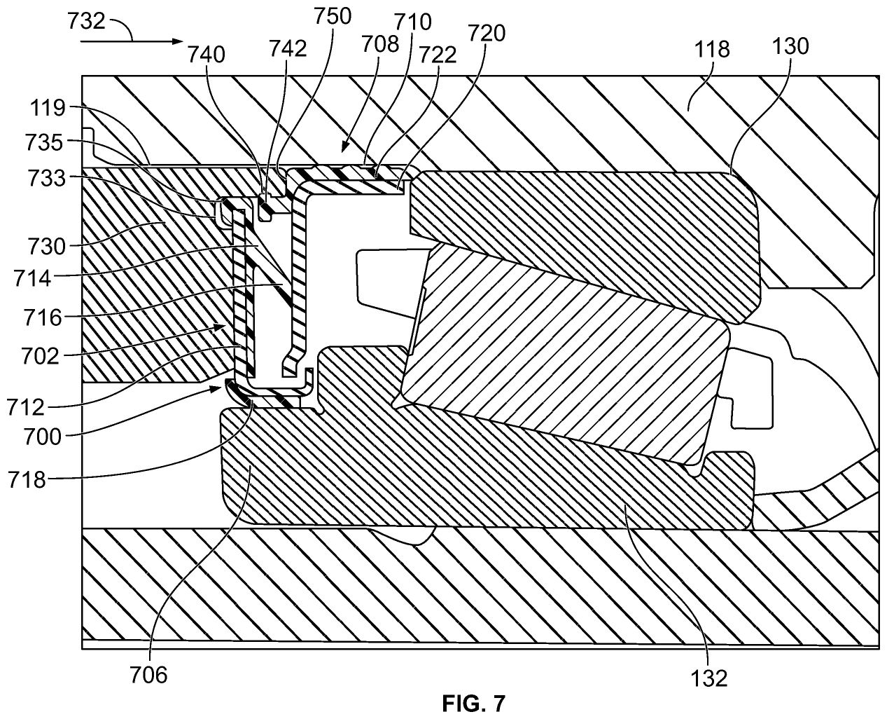

Regarding FIG. 7, a seal 700 is provided that is similar in many respects to the seals discussed above. The seal 700 includes an outboard seal body 702 and an inboard seal body 708. The outboard seal body 702 mounts to and extends around an extension portion 706 of the outboard bearing cone 132. The outboard seal body 702 includes a structural member 712, a first sealing layer 714 having a lip sealing member 716, and a second sealing layer 718. The second sealing layer 718 is configured to engage an outer diameter of the extension portion 706 of the outboard bearing cone 132 and form an oil-tight seal therebetween.

The inboard seal body 708 mounts to an annular, inner surface 710 of the bore 119 of the wheel hub body 118. The inboard seal body 708 has a structural member 720 and a sealing layer 722. The sealing layer 722 engages the inner surface 710 to form an oil-tight seal therebetween. In FIG. 7, an installation tool 730 is being advanced in an inboard direction 732 to advance the seal 700 into position in the bore 119. The installation tool 730 contacts the structural member 712 of the outboard seal body 702 and urges the outboard seal body 702 in direction 732 onto and along the extension portion 706 of the outboard bearing cone 132. The installation tool 730 has an annular groove 733 that receives an annular ridge 735 of the first sealing layer 714 to center the outboard seal body 702 on the installation tool 730.

The installation tool 730 has a notch 740 that receives a T-shaped flange 742 of the sealing layer 722 of the inboard seal body 708 to connect the installation tool 730 to the inboard seal body 708. Further, when the T-shaped flange 742 is engaged in the annular groove 733, the installation tool 730 provides a predetermined axial spacing between the outboard seal body 702 and the inboard seal body 708.

As the installation tool 730 is advanced in direction 732, the installation tool 730 contacts a radially extending flat 750 of the sealing layer 722 and urges the inboard seal body 708 in direction 732 until the inboard seal body 708 seats against the inboard bearing cup 130. In this manner, the installation tool 730 is configured to advance both the outboard seal body 702 and the inboard seal body 708 into position in the bore 119 of the wheel hub body 118.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

What is claimed is:

1. An oil seal for a wheel hub, the oil seal comprising:
an annular seal having a central opening to receive a vehicle spindle, the annular seal configured to inhibit the flow of oil through the annular seal;
an oil side of the annular seal for being contacted by oil in the wheel hub;
an air side of the annular seal opposite the oil side;
a radially outer mounting portion of the annular seal configured to sealingly engage an interior surface of the wheel hub and permit rotation of the radially outer mounting portion of the annular seal with the wheel hub around the vehicle spindle;
a sealing member of the annular seal having a contact portion configured to form a dynamic seal with a running surface, wherein one of the sealing member and the running surface is rotatable with the radially outer mounting portion of the annular seal relative to the other of the sealing member and the running surface; and
the contact portion of the sealing member is configured to form a pressure profile with the running surface that pumps oil toward the oil side of the annular seal upon rotation of the radially outer mounting portion of the annular seal with the wheel hub around the vehicle spindle.

2. The oil seal of claim 1 wherein the contact portion of the sealing member has an air side surface portion, an oil side surface portion, and a juncture therebetween; and
wherein the air side surface portion is configured to extend at a first angle relative to the running surface and the oil side surface portion is configured to extend at a second angle that is larger than the first angle.

3. The oil seal of claim 1 wherein the annular seal has a central axis and the radially outer mounting portion is rotatable around the central axis; and
wherein the radially outer mounting portion includes an annular, axial wall portion configured to form a press-fit engagement with the interior surface of the wheel hub.

4. The oil seal of claim 3 wherein the radially outer mounting portion includes a wall portion extending toward the central axis from the annular, axial wall portion.

5. The oil seal of claim 1 wherein the radially outer mounting portion is annular and has an outer diameter that is larger than an inner diameter of the inner surface of the wheel hub to form a press-fit engagement between the radially outer mounting portion and the inner surface of the wheel hub that inhibits oil from passing between the radially outer mounting portion and the inner surface of the wheel hub.

6. The oil seal of claim 1 wherein the radially outer mounting portion includes a metallic ring and an elastomeric member bonded to the metallic ring for engaging the inner surface of the wheel hub.

7. The oil seal of claim 1 wherein the annular seal comprises:
a first body configured to be mounted to a bearing cone in the wheel hub;
a second body rotatable relative to the first body and including the radially outer mounting portion; and
wherein one of the first body and the second body includes the sealing member and the other of the first body and the second body includes the running surface.

8. The oil seal of claim 7 wherein the first body includes a sleeve portion configured to form an oil-tight seal with the bearing cone.

9. The oil seal of claim 1 wherein the annular seal comprises a first body and a second body that are rotatable relative to one another about a central axis of the annular seal;
wherein the first body includes a sleeve portion for extending about a bearing cone and a wall portion extending away from the sleeve portion toward the central axis.

10. The oil seal of claim 1 in combination with a bearing cone, the bearing cone including the running surface.

11. The oil seal of claim 1 in combination with a bearing cone;
wherein the annular seal includes a first body configured to be mounted to the bearing cone and a second body including the radially outer mounting portion; and
wherein one of the first body and the second body includes the sealing member and the other of the first body and the second body includes the running surface.

12. The oil seal of claim 1 wherein the sealing member comprises a lip seal.

13. The oil seal of claim 1 wherein the annular seal includes an air vent.

14. A wheel hub assembly comprising:
a wheel hub body having an inboard end, an outboard end, and a bore extending therebetween to receive a vehicle spindle, the wheel hub extending around a central axis;
an axially extending inner surface of the wheel hub body defining at least a portion of the bore of the wheel hub body;
an inboard bearing assembly and an outboard bearing assembly in the bore of the wheel hub body, each of the inboard and outboard bearing assemblies including an inner race, an outer race, and a plurality of bearings between the inner and outer races that facilitate rotation of the outer race around the inner race;
an oil seal to inhibit oil from flowing in an outboard direction beyond the oil seal;
a mounting portion of the oil seal engaged with the inner surface of the wheel hub body outboard of the outer race of the outboard bearing assembly; and
a sealing member and a running surface of the oil seal, the sealing member engaged with the running surface to inhibit lubricant from traveling therebetween, wherein one of the sealing member and the running surface rotates with the mounting portion upon rotation of the wheel hub around the vehicle spindle relative to the other of the sealing member and the running surface.

15. The wheel hub assembly of claim 14 wherein the oil seal comprises a first seal body including the mounting portion and a second seal body mounted to the inner race of the outboard bearing assembly; and
wherein one of the first seal body and the second seal body includes the sealing member and the other of the first seal body and the second seal body includes the running surface.

16. The wheel hub assembly of claim 15 wherein the second seal body includes a sleeve portion extending around and engaged with the inner race of the outboard bearing.

17. The wheel hub assembly of claim 14 wherein the oil seal includes a first seal body including the mounting portion and a second seal body secured to the inner race of the outboard bearing assembly;
wherein one of the first seal body and the second seal body includes the sealing member and the other of the first seal body and the second seal body includes the running surface;
the wheel hub assembly further comprising a spindle lock nut configured to be secured to the vehicle spindle and secure the second body to the inner race of the outboard bearing assembly.

18. The wheel hub assembly of claim 14 wherein the mounting portion of the oil seal includes a ring of a first material and a seal member of a different, second material radially intermediate the ring and the inner surface of the wheel hub body.

19. The wheel hub assembly of claim 14 wherein the inner race of the outboard bearing includes:
an inboard bearing support surface that the bearings travel along upon rotation of the wheel hub about the vehicle spindle; and
an outboard extension outboard of the inboard bearing support surface.

20. The wheel hub assembly of claim 19 wherein the outboard extension of the inner race includes the running surface.

21. The wheel hub assembly of claim 19 wherein the oil seal includes a seal body mounted to the outboard extension of the inner race; and
wherein the seal body includes the running surface or the sealing member.

22. The wheel hub assembly of claim 14 wherein the seal includes a deflector between the sealing member and the outboard bearing assembly to direct lubricant away from the sealing member as the wheel heel hub rotates around the vehicle spindle.

23. The wheel hub assembly of claim 14 wherein the wheel hub body has a unitary, one-piece construction and includes a flange portion for mounting a wheel thereto.

24. The wheel hub assembly of claim 14 wherein the sealing member includes a lip seal.

25. The wheel hub assembly of claim 14 wherein the oil seal includes an air vent.

26. A method of assembling a wheel hub assembly, the method comprising:
advancing a first seal body of an oil seal into a bore of a wheel hub body in an inboard direction toward an outer race of an outboard bearing assembly in the bore;
engaging a mounting portion of the first seal body of the oil seal with the wheel hub body outboard of the outer race of the outboard bearing assembly; and
arranging a sealing member and a running surface of the oil seal so that the sealing member and running surface form a dynamic seal therebetween, wherein one of the sealing member and the running surface rotates with the wheel hub body relative to the other of the sealing member and the running surface.

27. The method of claim 26 further comprising:
advancing a second seal body of the oil seal into the bore in the inboard direction; and
positioning a sleeve portion of the second seal body around an inner race of the outboard bearing assembly.

28. The method of claim 26 further comprising:
advancing a second seal body of the oil seal into the bore in the inboard direction;
engaging the second seal body with an inner race of the outboard bearing assembly; and
wherein one of the first seal body and the second seal body includes the sealing member; and
wherein the other of the first seal body and the second seal body includes the running surface.

29. The method of claim 26 wherein the first seal body includes the sealing member;
wherein the outboard bearing assembly comprises an inner race that includes the running surface; and
wherein arranging the sealing member and the running surface comprises engaging a sealing member of the first seal body with the running surface of the inner race of the outboard bearing assembly.

30. The method of claim 26 wherein engaging the mounting portion of the first seal body with the body of the wheel hub comprises forming a press-fit engagement between the first seal body and an annular inner surface of the body of the wheel hub.

31. The method of claim 26 wherein the sealing member and running surface are configured to pump oil toward the outboard bearing assembly in response to rotation of the wheel hub body around a spindle.
